(19) United States
(12) Patent Application Publication
(10) Pub. No.: US 2013/0321444 A1
(43) Pub. Date: Dec. 5, 2013

(54) METHOD AND APPARATUS FOR TRANSITIONING BETWEEN PAGES ON A DISPLAY SCREEN

(71) Applicants: Tzahi Efrati, Givataim (IL); Uri Mischari, Oranit (IL)

(72) Inventors: Tzahi Efrati, Givataim (IL); Uri Mischari, Oranit (IL)

(21) Appl. No.: 13/485,231

(22) Filed: May 31, 2012

(51) Int. Cl. G09G 5/34; G09G 5/02

(52) U.S. Cl. 345/589

(57) ABSTRACT

A method and apparatus for scrolling between a plurality of pages on a display device associated with a computer. In one embodiment, the method includes displaying, by the display device, a first page disposed in front of at least one background layer, receiving, by the computer, an input to scroll from the first page to a second page disposed in front of the at least one background layer, scrolling, by the computer, from the first page to the second page, wherein the act of scrolling from the first page to the second page includes changing a color quotient of the at least one of the at least one background layer based on a change in position of a central part of the first page as the first page scrolls to the second page.

### BACKGROUND OF THE INVENTION

1. Field of the Invention

Embodiments consistent with the present invention generally relate to methods and apparatus for transitioning between a plurality of pages on a display device.

2. Description of the Related Art

Software applications are designed to perform many different functions and/or display many different types of information. Separate screens or pages within a single application may be required for each separate function provided, and each type of information displayed, by the application. As display devices reduce in size, the screen displays become more and more crowded to accommodate the many different functions and types of information that a user can access. The primary functionality or important features of an application may get lost and become obscured amongst the various different pages associated with an application.

In addition, including branding or application/service provider identifying information in an application is important to many application providers. However static branding or static service provider identifying information in an application may be ignored, or not otherwise not noticed, by users.

Thus there is a need for a method and apparatus to provide a better way of focusing a user's attention to various features within an application which the application provider deems important and to increase awareness of the application provider's branding.

### SUMMARY OF THE INVENTION

Methods and apparatus for scrolling between a plurality of pages on a display device are provided herein. In some embodiments, the method may include displaying, by the display device, a first page disposed in front of at least one background layer, receiving, by the computer, an input to scroll from the first page to a second page disposed in front of the at least one background layer, scrolling, by the computer, from the first page to the second page, wherein the act of scrolling from the first page to the second page includes changing a color quotient of the at least one of the at least one background layer based on a change in position of a central part of the first page as the first page scrolls to the second page.

According to some embodiments, changing a color quotient of the first background layer based on a change in position of a central part of the first page as the first page scrolls to the second page may include monitoring a distance from the central part of the first page to a central part of a viewable area of the display device, and changing a color quotient of the at least one of the at least one background layer as a function of the monitored distance from the central part of the first page to the central part of a viewable area of the display device as the first page scrolls to the second page.

Other and further embodiments of the present invention are described below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts an exemplary user interface in accordance with embodiments consistent with the present application;

FIG. 2 depicts an exemplary scrolling method for scrolling from a first page to a second page in viewable area in accordance with the least one embodiment of the present invention;

FIG. 3 depicts a flow diagram of a method for scrolling between a plurality of pages on a display device, according to one or more embodiments of the invention;

FIG. 4 depicts a screenshot of a first page according to one or more embodiments of the invention;

FIG. 5 depicts a screenshot of the first page starting to scroll to a second page according to one or more embodiments of the invention;

FIG. 6 depicts a screenshot of the first page continuing to scroll to the second page according to one or more embodiments of the invention;

FIG. 7 depicts a screenshot of the second page according to one or more embodiments of the invention; and

FIG. 8 is a detailed block diagram of a computer system, according to one or more embodiments.

While the method and apparatus for scrolling between a plurality of pages on a display device is described herein by way of example for several embodiments and illustrative drawings, those skilled in the art will recognize that method and apparatus for scrolling between a plurality of pages on a display device is not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of method and apparatus for scrolling between a plurality of pages on a display device as defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION

Embodiments of the present invention include a method and apparatus for transitioning (e.g., scrolling) between a plurality of pages on a display device. As a user transitions between various functional or informational pages of an application, various transitioning effects may be implemented to attract and/or focus the attention of the user by making certain functional pages of an application more prominent. For example, by fading in dramatic color changes in the background as the user scrolls or transitions from one page in an application to another page in the application, a user's attention will more likely be drawn to the new page. This may assist a user in identifying key functionality while making less important functionality or information less prominent. Transitioning effects consistent with at least some embodiments of the present invention may also be used to increase brand awareness of a service provider/application owner, or promote additional products or functionality.

Various embodiments of an apparatus and method for transitioning (e.g., scrolling) between a plurality of pages on a display device are provided below. In the following detailed description, numerous specific details are set forth to provide a thorough understanding of the claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description which follow are presented in terms of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

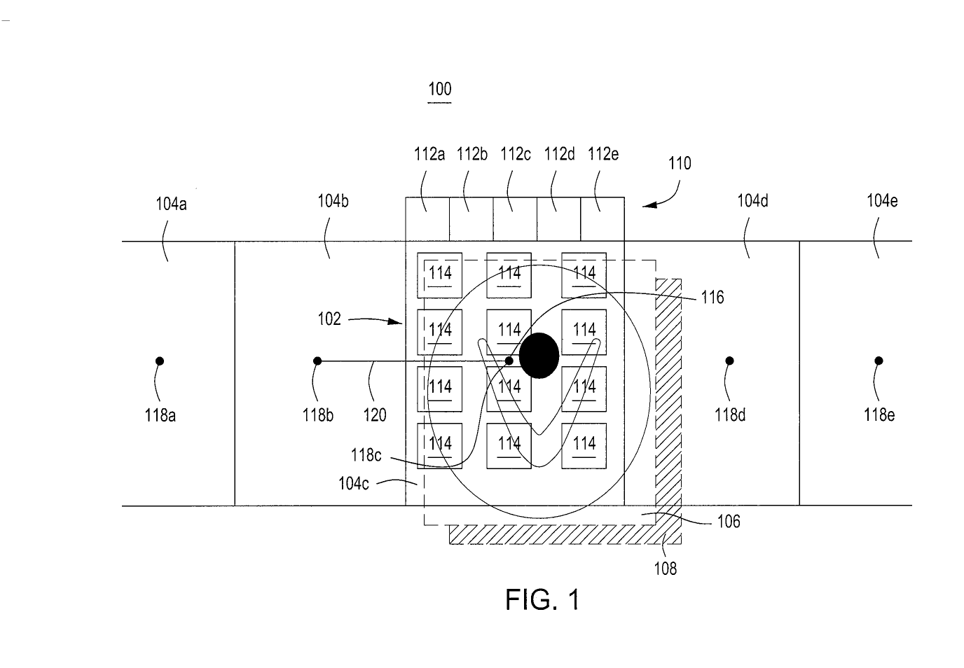

FIG. 1 depicts an exemplary user interface 100 in accordance with embodiments consistent with the present application.

The user interface 100 may include a defined viewable area 102 which can be scrolled. The scrollable viewable area 102 may display a plurality of pages 104a-104e, including various functional or informational pages, to a user.

In some embodiments, functional pages 104a-104e may include user selectable objects 114 to facilitate the desired functionality. For example, page 104c may include a dialer function which may consist of a plurality of selectable objects 114 to facilitate the dialing of phone numbers. According to some embodiments, functional pages 104a-104e may include contact information for selecting and communicating with a desired contact, a chat page for interacting with another person via chat, an account balance page for checking account balances and adding additional funds to a user's account, and the like.

According to some embodiments, at least some of the plurality of pages 104a-104e may include static or dynamic information for display to the user. For example, in some embodiments, at least some of the plurality of pages 104a-104e may display information such as recently called phone numbers or contacts (not shown).

A user may scroll between the plurality of pages 104a-104e using a number of input methods. In some embodiments consistent with the present application, a user may swipe a touch-sensitive screen to scroll from page to page in user interface 100. In other embodiments, a user may use a mouse input to select a specific page. User interface 100 may also include a menu area 110 which may include a plurality of selectable menu objects 112a-112e. Each menu object 112a-112e may take a user to a specific page when selected. In some embodiments, menu area 110 may be fixed such that it does not scroll as a user scrolls between pages 104a-104e. In other embodiments, menu area 110 may be separately scrollable such that it can be scrolled to display additional selectable menu objects, but scrolls independently from pages 104a-104e.

The user interface 100 may also include one or more background layers 106 and 108 disposed behind viewable area 102 and the plurality of pages 104a-104e. Please note that one or more background layers 106 and 108 are generally aligned with viewable area 102 but are depicted off-center from viewable area 102 in FIG. 1 for viewability purposes. Although FIG. 1 depicts two background layers, it should be noted that more or fewer background layers may be used in user interface 100. The background layers 106 and 108 are typically non-functional layers which may include static images, solid or patterned backgrounds in color or grayscale, video images, and the like. For example, in at least some embodiments consistent with the present application, background layer 106 and/or 108 may be an image of a company logo which may be visible through each of the plurality of pages 104a-104e. It should be noted that functional backgrounds may be used in alternate embodiments consistent with the present application (for example, making certain object selectable/opaque or not selectable/transparent when scrolling for one page to another page).

Background layers 106 and 108 may be disposed behind the scrollable plurality of pages 104a-104e. In at least some embodiments consistent with the present application, a color quotient of each of the plurality of pages 104a-104e are such that at least one of background layers 106 and 108 may be visible through the pages 104a-104e displayed in viewable area 102. In addition, in at least some embodiments consistent with the present application, the color quotient of each of the selectable objects 114 on pages 104a-104e may be such that at least one of background layers 106 and 108 may be visible through the selectable objects 114. A color quotient is generally intended to describe a value of a transparently/opacity level (e.g., Alpha levels), Red Green Blue (RGB) value, and/or other values for parameters which may affect the way an object, image, or background is displayed or otherwise perceived by a user.

In at least some embodiments consistent with the present application background layer 108 may be disposed behind background layer 106. The color quotient of the background layer 106 may be set such that background layer 108 is visible, partially visible, or not visible through background layer 106.

According to some embodiments consistent with the present application background layers 106 and 108 may be fixed in position such that they cannot be scrolled as pages 104a-104e are scrolled in front of them. In other embodiments, each page 104a-104e may include a separate background layer(s) 106, 108 that scrolls along with the page 104a-104e it is associated with.

A central area 116 of the viewable area 102 is shown in FIG. 1. In addition, each of the plurality of pages 104a-104e has a respective central area 118a-118e. A position of central areas 118a-118e is used to determine which page 104a-104e is visible or how far a page 104a-104e is scrolled if not visible or partially visible in viewable area 102. For example, distance 120 of the central area 118b of page 104b from central area 116 of the viewable area 102 may be monitored to determine if page 104b is visible and/or how far it is scrolled. In at least some embodiments consistent with the present application, distance 120 may be used to adjust a color quotient of background layer 106. In other embodiments, distance 120 may be used, for example, to adjust a color quotient of at least one of pages 104a-104e and/or background layer 108.

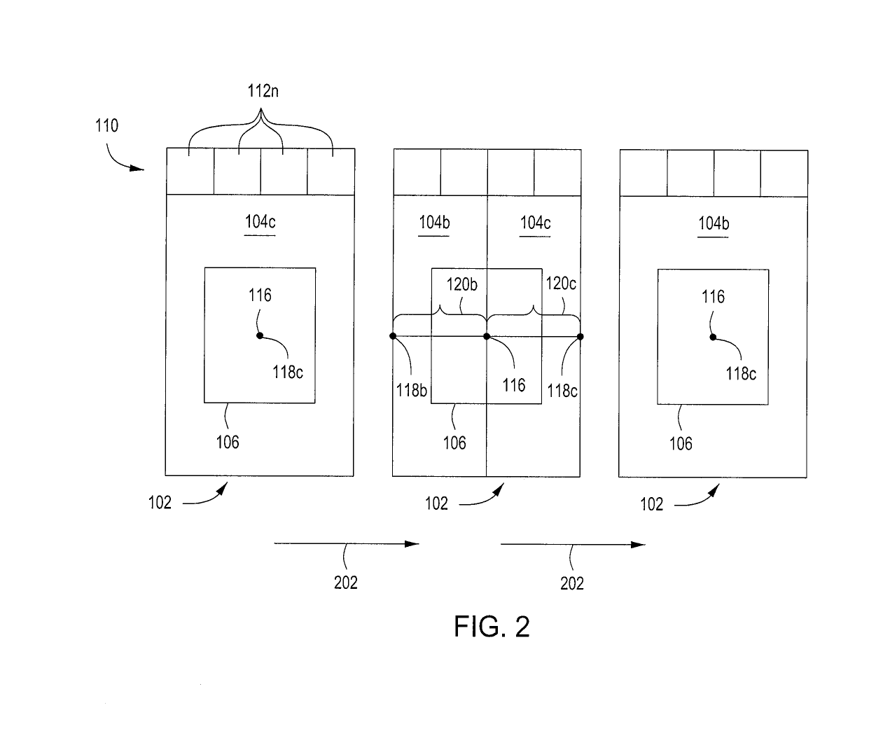

FIG. 2 depicts an example embodiment of a first page 104c scrolling to a second page 104b in viewable area 102. In one exemplary embodiment consistent with FIG. 2, the distance 120c between the central area 118c of page 104c and the central area 116 of the scrollable viewable area 102 are aligned (left most image of FIG. 2). After an input (e.g., user swipe gesture, selection of menu objects 112a-112e, and the like) is received to transition from a first page 104c to a second page 104b, page 104c begins to move in scroll direction 202. Note that menu area 110 remains stationary in this embodiment, but may be separately or independently scrollable in other embodiments consistent with the present application.

The distance 120c between the central area 118c of page 104c and the central area 116 of the scrollable viewable area 102 begins to increase as page 104c scrolls further to the right. Simultaneously, the distance 120b between the central area 118b of page 104b and the central area 116 of the scrollable viewable area 102 begins to decrease as page 104b scrolls further to the right until the central area 118b of page 104b and the central area 116 of the scrollable viewable area 102 are aligned. In some embodiments discussed herein, distance 120c and/or distance 120b may be used to adjust the color quotient of background layer 106.

Although the scrolling described above with respect to FIG. 2 is from the left to the right, it should be noted that pages may be scrolled, for example (but not limited to), from right to left, top to bottom, and bottom to top, or in any suitable manner of transitioning from one page to another page in embodiments consistent with the present application.

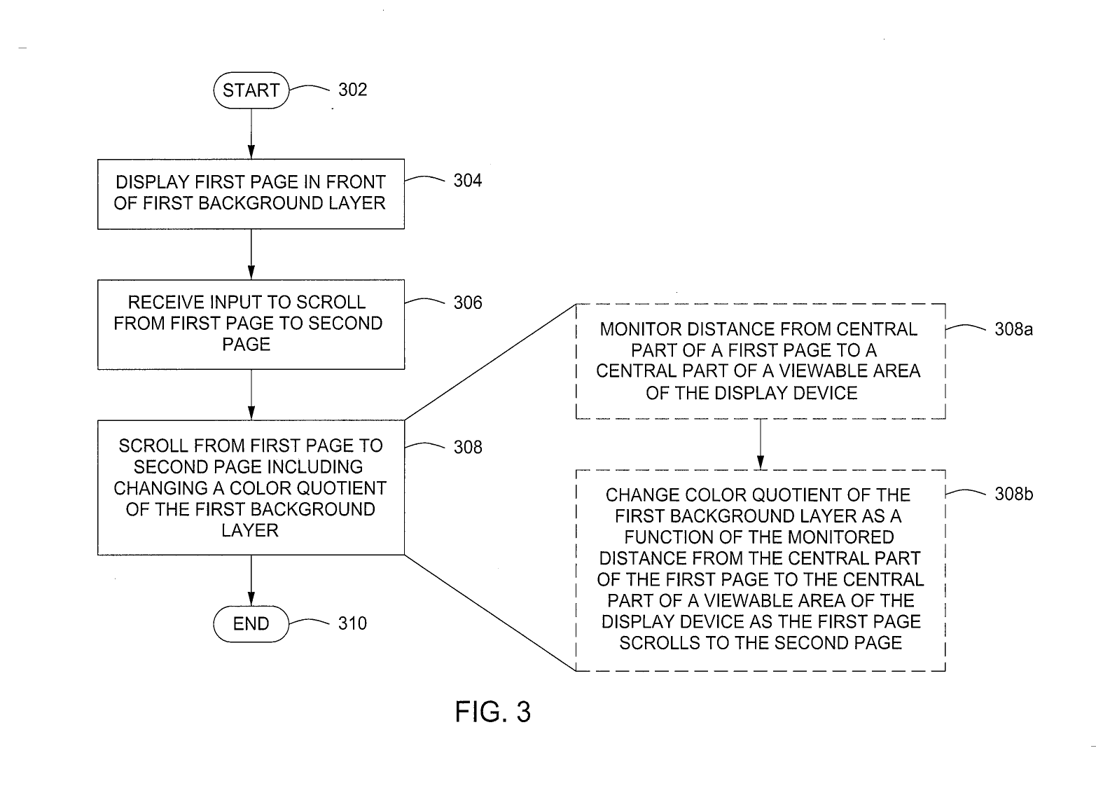

FIG. 3 depicts a flow diagram of a method 300 for scrolling between a plurality of pages on a display device, according to one or more embodiments of the invention. The method 300 starts at step 302, and generally proceeds to step 304.

At step 304, a first page disposed in front of a first background layer is displayed by a display device. The first background layer may be visible, partially visible, or not visible through the first page. At step 306, an input to scroll from the first page to a second page is received. Examples of such inputs may include a user finger swipe across a touch-sensitive screen, a mouse input to select a specific page, a selection of a menu objects, and the like. At step 308, the first page scrolls to the second page. In some embodiments consistent with the present application, the act of scrolling from the first page to the second page may include changing a color quotient of the first background layer based on a change in position of a central part of the first page as the first page scrolls to the second page at step 308. For example, if the first background layer is visible through the first page, the color quotient of the background layer may be changed as the first page scrolls to the second page such that it becomes only partially visible or not at all visible through the second page. According to some embodiments, a distance from the central part of the first page to a central part of a viewable area of the display device may be monitored at step 308a, and the color quotient of the first background layer may be changed as a function of the monitored distance from the central part of the first page to the central part of a viewable area of the display device as the first page scrolls to the second page at step 308b. The method 300 then ends at step 310.

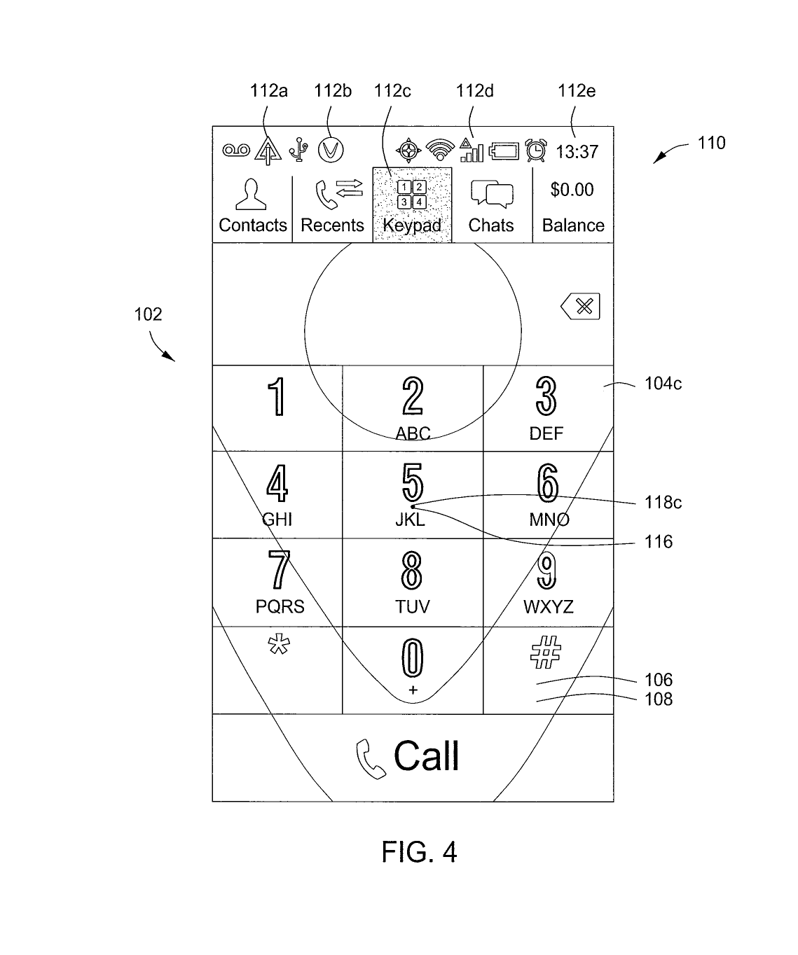

FIG. 4-7 depict an exemplary sequence of screenshots as a first page is scrolled to a second page in accordance with some embodiments consistent with the present application. FIG. 4 shows a first function page 104c as a keypad or dialer function in viewable area 102. As depicted in FIG. 4, a first background layer 106 is visible through page 104c, and includes an enlarged image of the “V and dot” logo used by Vonage Holdings Corp.

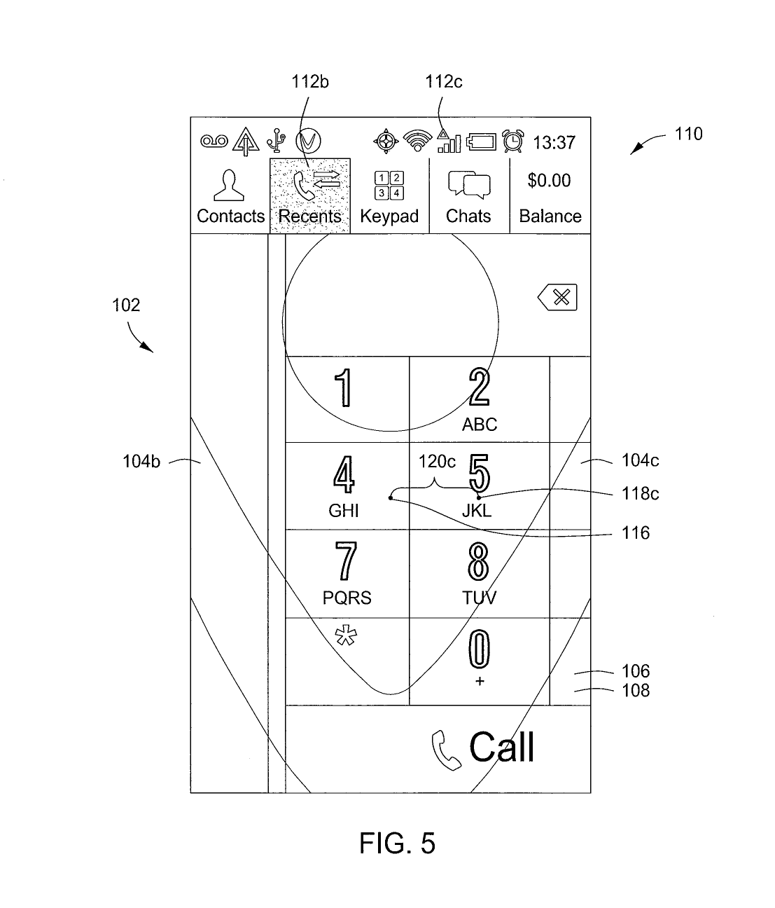

An input may be received to scroll from a Keypad page 104c to a Recents page 104b. As described above, the input may be a swipe of a user's finger (or stylus) across a touch-sensitive screen, or it may be a user selection of one of selectable menu objects 112a-112e in menu area 110. FIG. 5 shows Keypad page 104c scrolling out of viewable area 102, and Recents page 104b scrolling into viewable area 102 from left to right. As Keypad page 104c and its central area 118c move to the right (and distance 120c begins to increase), the transparency of the first background layer 106 is increased (i.e., the first background layer 106 becomes less visible) and a second background layer 108 begins to become visible through the first background layer 106 and pages 104c and 104b. In the embodiment shown in FIG. 5, the second background layer 108 is a solid color grayscale background although in other embodiments other backgrounds may be used. Thus, as the distance 120c between central area 118c of Keypad page 104c and central area 116 of viewable area 102 increases, the transparency of first background layer 106 is increased (or the opaqueness of first background layer 106 is decreased, or the RGB levels of first background layer 106 is changed), such that the second background becomes more and more visible.

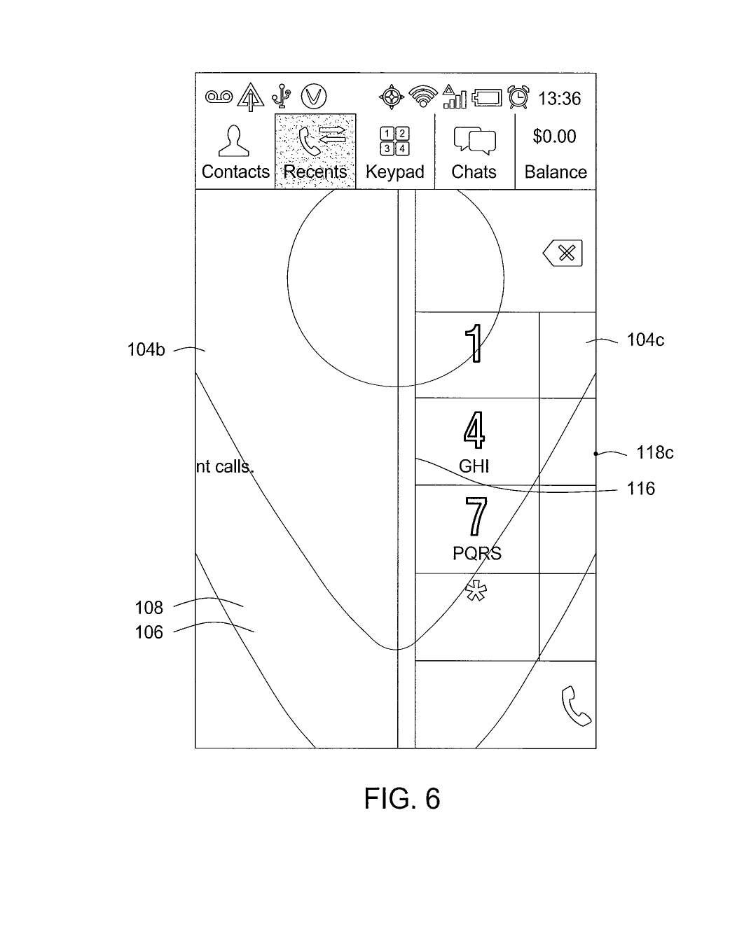

FIG. 6 further illustrates the aforementioned transitioning effect as Keypad page 104c is further scrolled to the right out of viewable area 102, and Recents page 104b is scrolled into viewable area 102. Note that the transparency of first background layer 106 is further increased from FIG. 5 and the grayscale background included in the second background layer 108 becomes more visible than shown in FIG. 5. That is, as the distance between central area 118c of Keypad page 104c and central area 116 of viewable area 102 increases, the transparency of first background layer 106 is increased (or the opaqueness of first background layer 106 is decreased, or the RGB levels of first background layer 106 is changed), such that the second background becomes more and more visible.

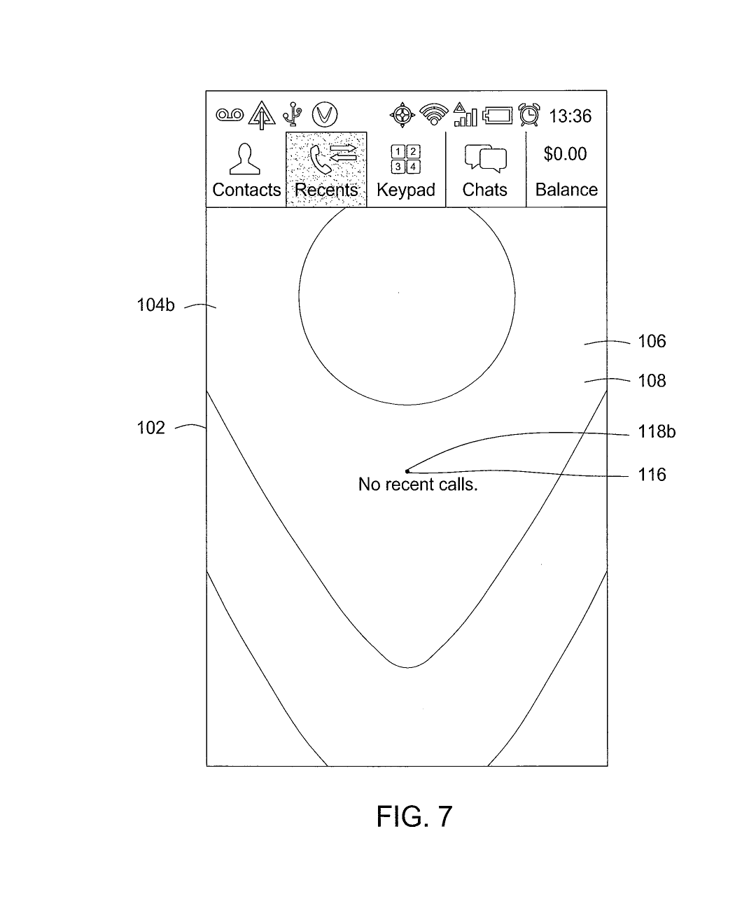

FIG. 7 shows Recents page 104b in viewable area 102 after the transition from Keypad page 104c to Recents page 104b has completed. Note that central area 116 of viewable area 102 is now aligned with central area 118b of Recents page 104b. Also note that the transparency of first background layer 106 is further increased from FIG. 6, and the grayscale background included in the second background layer 108 is more visible than shown in FIG. 6.

The embodiments of the present invention may be embodied as methods, apparatus, electronic devices, and/or computer program products. Accordingly, the embodiments of the present invention may be embodied in hardware and/or in software (including firmware, resident software, micro-code, and the like), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus or device. More specific examples (a non exhaustive list) of the computer-readable medium include the following: hard disks, optical storage devices, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java®, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

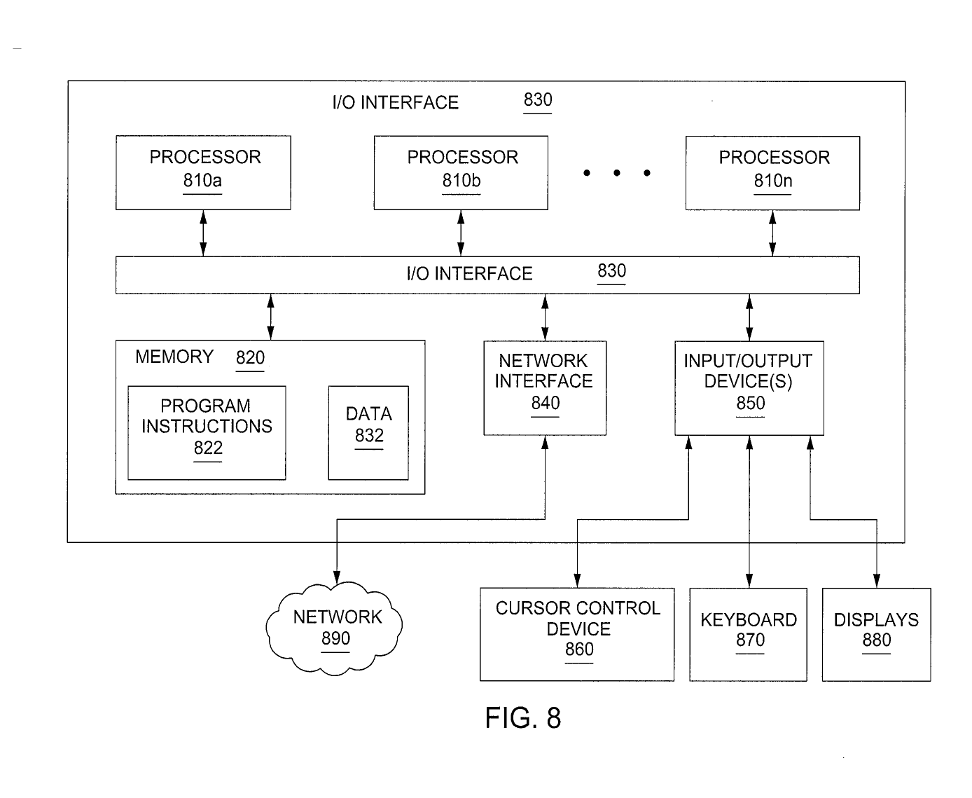

FIG. 8 depicts a computer system 800 that can be utilized in various embodiments of the present invention to implement the computer and/or the display, according to one or more embodiments.

Various embodiments of method and apparatus for transitioning between a plurality of pages on a display device, as described herein, may be executed on one or more computer systems, which may interact with various other devices. One such computer system is computer system 800 illustrated by FIG. 8, which may in various embodiments implement any of the elements or functionality illustrated in FIGS. 1-7. In various embodiments, computer system 800 may be configured to implement methods described above. The computer system 800 may be used to implement any other system, device, element, functionality or method of the above-described embodiments. In the illustrated embodiments, computer system 800 may be configured to implement method 300 as processor-executable executable program instructions 822 (e.g., program instructions executable by processor(s) 810) in various embodiments.

In the illustrated embodiment, computer system 800 includes one or more processors 810a-810n coupled to a system memory 820 via an input/output (I/O) interface 830. Computer system 800 further includes a network interface 840 coupled to I/O interface 830, and one or more input/output devices 850, such as cursor control device 860, keyboard 870, and display(s) 880. In various embodiments, any of the components may be utilized by the system to receive user input described above. In various embodiments, a user interface (e.g., user interface 100) may be generated and displayed on display 880. In some cases, it is contemplated that embodiments may be implemented using a single instance of computer system 800, while in other embodiments multiple such systems, or multiple nodes making up computer system 800, may be configured to host different portions or instances of various embodiments. For example, in one embodiment some elements may be implemented via one or more nodes of computer system 800 that are distinct from those nodes implementing other elements. In another example, multiple nodes may implement computer system 800 in a distributed manner.

In different embodiments, computer system 800 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 800 may be a uniprocessor system including one processor 810, or a multiprocessor system including several processors 810 (e.g., two, four, eight, or another suitable number). Processors 810 may be any suitable processor capable of executing instructions. For example, in various embodiments processors 810 may be general-purpose or embedded processors implementing any of a variety of instruction set architectures (ISAs). In multiprocessor systems, each of processors 810 may commonly, but not necessarily, implement the same ISA.

System memory 820 may be configured to store program instructions 822 and/or data 832 accessible by processor 810. In various embodiments, system memory 820 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 820. In other embodiments, program instructions and/or data may be received, sent or stored upon different types of computer-accessible media or on similar media separate from system memory 820 or computer system 800.

In one embodiment, I/O interface 830 may be configured to coordinate I/O traffic between processor 810, system memory 820, and any peripheral devices in the device, including network interface 840 or other peripheral interfaces, such as input/output devices 850. In some embodiments, I/O interface 830 may perform any necessary protocol, timing or other data transformations to convert data signals from one component (e.g., system memory 820) into a format suitable for use by another component (e.g., processor 810). In some embodiments, I/O interface 830 may include support for devices attached through various types of peripheral buses, such as a variant of the Peripheral Component Interconnect (PCI) bus standard or the Universal Serial Bus (USB) standard, for example. In some embodiments, the function of I/O interface 830 may be split into two or more separate components, such as a north bridge and a south bridge, for example. Also, in some embodiments some or all of the functionality of I/O interface 830, such as an interface to system memory 820, may be incorporated directly into processor 810.

Network interface 840 may be configured to allow data to be exchanged between computer system 800 and other devices attached to a network (e.g., network 890), such as one or more external systems or between nodes of computer system 800. In various embodiments, network 890 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 840 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 850 may, in some embodiments, include one or more display terminals, keyboards, keypads, touchpads, scanning devices, voice or optical recognition devices, or any other devices suitable for entering or accessing data by one or more computer systems 800. Multiple input/output devices 850 may be present in computer system 800 or may be distributed on various nodes of computer system 800. In some embodiments, similar input/output devices may be separate from computer system 800 and may interact with one or more nodes of computer system 800 through a wired or wireless connection, such as over network interface 840.

In some embodiments, the illustrated computer system may implement any of the methods described above, such as the methods illustrated by the flowcharts of FIG. 3. In other embodiments, different elements and data may be included.

Those skilled in the art will appreciate that computer system 800 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 800 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 800 may be transmitted to computer system 800 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

The foregoing description of embodiments of the invention comprises a number of elements, devices, circuits and/or assemblies that perform various functions as described. For example, display 880 is an example of a means for displaying a first page disposed in front of a first background layer, input/output device 850 is an example of a means for receiving an input to scroll from the first page to a second page, and one or more processors 810a-810n are an example of a means for scrolling from the first page to the second page, wherein the act of scrolling from the first page to the second page includes changing a color quotient of the first background layer based on a change in position of a central part of the first page as the first page scrolls to the second page. These elements, devices, circuits, and/or assemblies are exemplary implementations of means for performing their respectively described functions.

While the foregoing is directed to embodiments of the present invention, other and further embodiments of the invention may be devised without departing from the basic scope thereof, and the scope thereof is determined by the claims that follow.

What is claimed is:

1. A computer-implemented method for scrolling between a plurality of pages on a display device associated with a computer comprising:
displaying, by the display device, a first page disposed in front of at least one background layer;
receiving, by the computer, an input to scroll from the first page to a second page disposed in front of the at least one background layer; and
scrolling, by the computer, from the first page to the second page, wherein the act of scrolling from the first page to the second page includes changing a color quotient of the at least one of the at least one background layer based on a change in position of a central part of the first page as the first page scrolls to the second page.

2. The computer-implemented method of claim 1 wherein changing a color quotient of the at least one of the at least one background layer based on the change in position of the central part of the first page as the first page scrolls to the second page includes:
(a) monitoring a distance from the central part of the first page to a central part of a viewable area of the display device; and
(b) changing the color quotient of the at least one of the at least one background layer as a function of the monitored distance from the central part of the first page to the central part of the viewable area of the display device as the first page scrolls to the second page.

3. The computer-implemented method of claim 1 wherein a color quotient of the first page and a color quotient of the second page are set such that at least one of the at least one background layer disposed behind the first and second page can be visible through the first and second pages.

4. The computer-implemented method of claim 3 wherein a first background layer (a) is visible through the first page and (b) is disposed in front of a second background layer which is not visible through the first background layer or the first page, and wherein changing the color quotient of the first background layer as the first page scrolls to the second page includes increasing a transparency level of the first background layer such that the second background layer becomes visible through the first background layer, the first page, and the second page.

5. The computer-implemented method of claim 3 wherein a first background layer is disposed in front of a second background layer which is visible through the first background layer and the first page, and wherein changing the color quotient of the first background layer as the first page scrolls to the second page includes decreasing a transparency level of the first background layer such that the second background layer is not visible through the first background layer, the first page, and the second page.

6. The computer-implemented method of claim 1 wherein the first and second pages are functional pages including at least one of (a) selectable objects, (b) dynamically changing information, or (c) static information.

7. The computer-implemented method of claim 1 wherein the input received to scroll from the first page to the second page is a finger swipe across a touch sensitive screen associated with the computer.

8. The computer-implemented method of claim 1 wherein a row of selectable menu objects is displayed proximate to the first and second pages, and wherein the input received to scroll from the first page to the second page is a selection of one of the selectable menu objects.

9. The computer-implemented method of claim 1 wherein each of the at least one background layer includes one of (a) a digital image, (b) a solid color or (c) a digital video.

10. The computer-implemented method of claim 9 wherein changing the color quotient of the at least one background layer includes at least one of (a) changing an Alpha channel of the at least one background layer or (b) modifying the Red Green Blue (RGB) channels of the at least one background layer.

11. The computer-implemented method of claim 1 wherein the first and second background layers are fixed at a constant location and wherein the plurality of pages are scrollable in front of the at least one background layer.

12. An apparatus for scrolling between a plurality of pages on a display device, comprising:
a) at least one processor;
b) at least one input device; and
c) at least one storage device storing processor-executable instructions which, when executed by the at least one processor, perform a method including
displaying a first page disposed in front of at least one background layer;
receiving an input to scroll from the first page to a second page disposed in front of the at least one background layer; and
scrolling from the first page to the second page, wherein the act of scrolling from the first page to the second page includes changing a color quotient of the at least one of the at least one background layer based on a change in position of a central part of the first page as the first page scrolls to the second page.

13. The apparatus of claim 12 wherein changing a color quotient of the at least one of the at least one background layer based on the change in position of the central part of the first page as the first page scrolls to the second page includes:
(a) monitoring a distance from the central part of the first page to a central part of a viewable area of the display device; and
(b) changing the color quotient of the at least one of the at least one background layer as a function of the monitored distance from the central part of the first page to the central part of the viewable area of the display device as the first page scrolls to the second page.

14. The apparatus of claim 12 wherein a color quotient of the first page and a color quotient of the second page are set such that at least one of the at least one background layer disposed behind the first and second page can be visible through the first and second pages.

15. The apparatus of claim 14 wherein a first background layer (a) is visible through the first page and (b) is disposed in front of a second background layer which is not visible through the first background layer or the first page, and wherein changing the color quotient of the first background layer as the first page scrolls to the second page includes increasing a transparency level of the first background layer such that the second background layer becomes visible through the first background layer, the first page, and the second page.

16. The apparatus of claim 14 wherein a first background layer is disposed in front of a second background layer which is visible through the first background layer and the first page, and wherein changing the color quotient of the first background layer as the first page scrolls to the second page includes decreasing a transparency level of the first background layer such that the second background layer is not visible through the first background layer, the first page, and the second page.

17. The apparatus of claim 12 wherein the input received to scroll from the first page to the second page is a finger swipe across a touch sensitive screen associated with the computer.

18. The apparatus of claim 12 wherein each of the at least one background layer includes one of (a) a digital image, (b) a solid color or (c) a digital video.

19. The computer-implemented method of claim 18 wherein changing the color quotient of the at least one background layer includes at least one of (a) changing an Alpha channel of the at least one background layer or (b) modifying the Red Green Blue (RGB) channels of the at least one background layer.

20. A computer-implemented method for scrolling between a plurality of pages on a display device associated with a computer comprising:
displaying, by the display device, a first page disposed in front of at least one background layer;
receiving, by the computer, an input to scroll from the first page to a second page disposed in front of the at least one background layer; and
scrolling, by the computer, from the first page to the second page, wherein the act of scrolling from the first page to the second page includes changing a color quotient of at least one of the first page or the second page based on a change in position of a central part of the second page as the first page scrolls to the second page.
